(19) United States
(12) Patent Application Publication
(10) Pub. No.: US 2024/0121620 A1
(43) Pub. Date: Apr. 11, 2024

(54) UNDERLAY SCHEME FOR SHORT-RANGE SECONDARY COMMUNICATION

(71) Applicant: UNIVERSITY OF VIRGINIA PATENT FOUNDATION, Charlottesville, VA (US)

(72) Inventors: Mohamed Salaheldeen IBRAHIM, Charlottesville, VA (US); Nikolaos Dimitrios Sidiropoulos, Keswick, VA (US)

(73) Assignee: UNIVERSITY OF VIRGINIA PATENT FOUNDATION, Charlottesville, VA (US)

(21) Appl. No.: 18/257,188

(22) PCT Filed: Dec. 10, 2021
(86) PCT No.: PCT/US2021/062767

§ 371 Date: Jun. 13, 2023

Related U.S. Application Data
(60) Provisional application No. 63/125,042, filed on Dec. 14, 2020.
(60) Provisional application No. 63/163,308, filed on Mar. 19, 2021.
(60) Provisional application No. 63/178,621, filed on Apr. 23, 2021.

(51) Int. Cl. H04W 16/14

(52) U.S. Cl. CPC H04W 16/14

(57) ABSTRACT

Embodiments relate to a dynamic spectrum access (DSA) system including a DSA transmitter configured to generate a complex signal for a secondary communication system, the complex signal being within a communication band A that is equal to or falls within a communication band B of a primary communication system. The complex signal includes a first signal and a second signal that is a repeat of the first signal. The power of the complex signal received at the secondary communication receiver is greater than the noise floor of the secondary communication system, but is equal to or less than the interference power from the primary communication. The DSA system includes a DSA receiver including a plurality of DSA antennas and a DSA signal processing module, the DSA signal processing module configured to perform canonical correlation analysis (CCA) on the complex signal.

### CROSS-REFERENCE TO RELATED APPLICATIONS

This application is related to and claims the benefit of priority of U.S. Provisional Application No. 63/125,042 fled on Dec. 14, 2020, U.S. Provisional Application No. 63/163,308 filed on Mar. 19, 2021, and U.S. Provisional Application No. 63/178,621 filed on Apr. 23, 2021, the entire contents of each are incorporated herein by reference.

### STATEMENT REGARDING FEDERALLY SPONSORED RESEARCH AND DEVELOPMENT

This invention was made with government support under Grant Nos. 1807660 and 1852831, awarded by the National Science Foundation. The government has certain rights in the invention.

### FIELD

Embodiments relate to a dynamic spectrum access (DSA) system that allows for short-range communications via a secondary communication system using a low-power signal that is within a communication band of a primary communication system.

### BACKGROUND INFORMATION

The unprecedented growth in wireless Internet-of-Things and WiFi devices has renewed interest in mechanisms for efficient spectrum reuse. Existing schemes require some level of primary-secondary coordination, cross-channel state estimation and tracking, or activity detection—which complicate implementation. For low-power short-range secondary communication, the main impediment is strong and time-varying (e.g., intermittent) interference from the primary system.

Embodiments disclosed herein provide technical solutions to overcome the problems with existing communication schemes.

### SUMMARY

An exemplary embodiment relates to a dynamic spectrum access (DSA) system. The DSA system can include a DSA transmitter configured to generate a complex signal for a secondary communication system. It is contemplated for the complex signal to be within a communication band A that is equal to or falls within a communication band B of a primary communication system. The complex signal can include a first signal and a second signal that is a repeat of the first signal. The DSA system can include a DSA receiver. The power of the complex signal should be greater than the noise floor of the secondary communication system—i.e., the power of the complex signal received at the DSA receiver should be greater than the noise floor of the DSA receiver. It is contemplated for the power of the complex signal to be equal to or less than the interference power from the primary communication, but some embodiments can involve a complex signal having a power that is greater than the interference power. The DSA receiver can include a plurality of DSA antennas and a DSA signal processing module. The DSA signal processing module can be configured to perform canonical correlation analysis (CCA) on the complex signal.

Another exemplary embodiment of the dynamic spectrum access (DSA) system includes a DSA transmitter having a DSA data packet repeater module. The DSA transmitter can be configured to generate a complex signal that includes a first signal and a second signal that is a repeat of the first signal. The DSA system can include a DSA receiver having a plurality of DSA antennas and a DSA signal processing module. The DSA signal processing module can be configured to perform canonical correlation analysis (CCA) on the complex signal.

An exemplary method of providing dynamic spectrum access (DSA) can involve generating a complex signal for a secondary communication system. The complex signal can be within a communication band A that is equal to or falls within a communication band B of a primary communication system. The complex signal can include a first signal and a second signal that is a repeat of the first signal. The method can involve performing canonical correlation analysis (CCA) based time synchronization and/or CCA based signal decoding on the complex signal.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1 shows an exemplary dynamic spectrum access system configuration;

FIG. 2 shows an exemplary secondary receiver operation for an embodiment of the dynamic spectrum access system;

FIG. 3 shows an exemplary architecture block diagram of embodiments of primary and secondary communication systems;

FIG. 4 shows 40 dB received power difference between a primary transmitter and a secondary transmitter at the secondary receiver measured by a GNU radio spectrum analyzer;

FIG. 5 shows squared samples of one of the received packets after matched filtering;

FIGS. 6A-6D show characteristics of received primary user's packets at a secondary receiver after matched filtering with the square-root raised cosine (SRRC) for 20 dB and 40 dB transmit power difference, wherein FIGS. 6A and 6B are plots depicting the symbol energy of the detected packet, for the two transmit power imbalance scenarios, while FIGS. 6C and 6D correspond to the estimated probability distribution of the energy (in dB) of the detected symbols for the 20 dB and 40 dB transmit power difference cases, respectively;

FIG. 7 shows secondary user detection performance at different average SINR levels;

FIG. 8A shows primary packet samples when the secondary transmitter is inactive, FIG. 8B shows primary packet samples when the secondary transmitter is active, FIG. 8C shows energy distribution when the secondary transmitter is inactive, and FIG. 8D shows energy distribution when the secondary transmitter is active;

FIG. 9 shows secondary user detection performance at different SNR;

FIG. 10 shows secondary user detection performance for different packet sizes of the secondary user; and

FIG. 11 shows secondary user synchronization using CCA.

### DETAILED DESCRIPTION

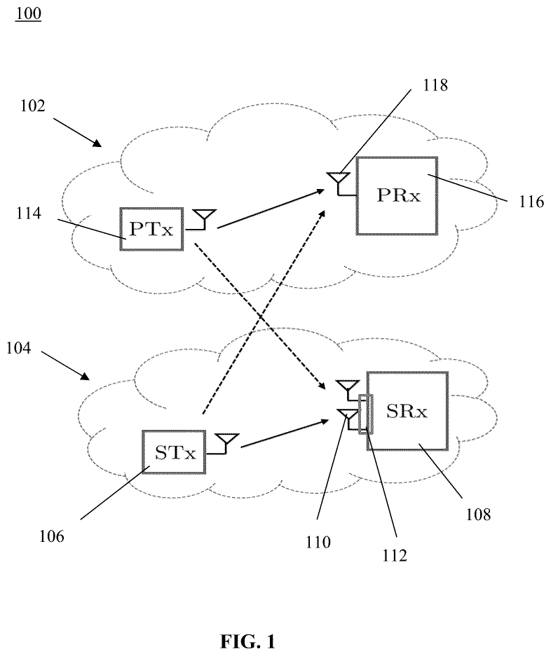

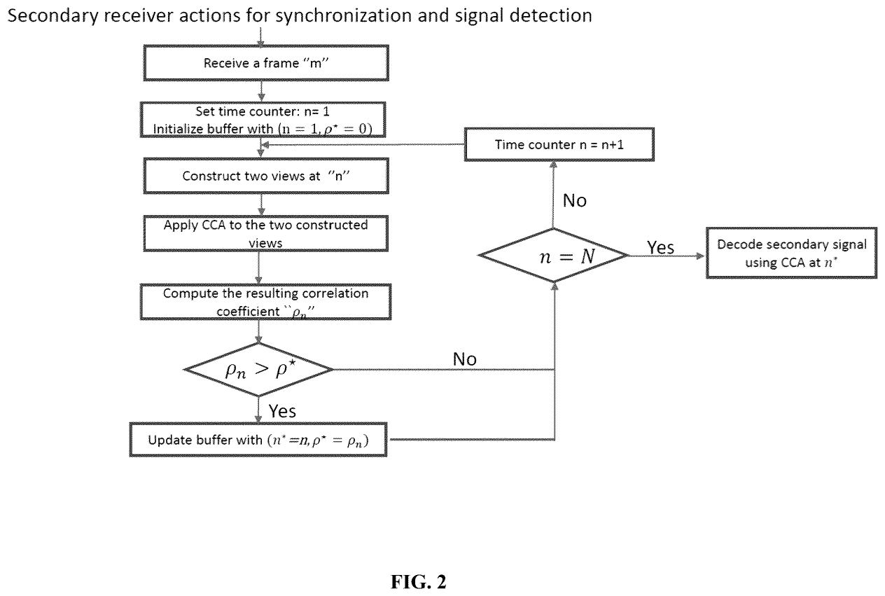

Referring to FIGS. 1-3, an exemplary embodiment relates to a dynamic spectrum access (DSA) system 100. Generally, a DSA framework is one designed to allow communication frequency bands or communication channels to be shared by communication devices/networks. The disclosed DSA system 100 can be configured to allow short-range communications via a secondary communication system 104 using a signal that is within a communication band of a primary communication system 102. Thus, with the inventive DSA system 100, a user using a secondary communication system 104 designed to transmit short-range communications can operate in the presence of a primary communication system 102 and transmit its short-range communication signals within a communication band of the primary communication system 102.

The DSA system 100 can include a DSA transmitter 106 configured to generate a complex signal for the secondary communication system 104. The DSA transmitter 106 can be a short-range transmitter. For instance, the DSA transmitter 106 can be configured for wireless communication within a smaller diameter region (e.g., 1 millimeter to several hundred meters). Exemplary short-region wireless communication modes include UWB, Wi-Fi, ZigBee and Bluetooth infrared, near field communication, etc.

The complex signal can include two real signals, wherein a first real signal corresponds to a real part of the complex signal and a second real signal corresponds to an imaginary part of the complex signal. It is contemplated for the complex signal to be within a communication band A that is equal to or falls within a communication band B of the primary communication system 102. The primary communication system 102 can be a long-range communication system (e.g., a radio station communication network (AM or FM radio), a satellite communication network, a cellular communication network, etc.). The complex signal can include a first signal and a second signal that is a repeat of the first signal. The power of the complex signal should be greater than the noise floor (the measure of the signal created from the sum of all the noise sources and unwanted signals within a measurement system) of the secondary communication system 104. Thus, the power of the complex signal when received at the DSA receiver 108 should be greater than the noise floor of the DSA receiver 108. It is contemplated for the power of the complex signal to be equal to or less than the interference power from the primary communication system 102. Interference power is the power of the primary communication system 102 as received at the secondary communication receiver (e.g., the DSA receiver 108). An exemplary way of determining interference power can involve multiplying a ratio of the overlapping bandwidths to the desired bandwidth of the communication system intended for use, by the total channel power. It should be noted that embodiments can involve a complex signal having a power that is greater than the interference power. Yet, particular benefits can be realized when the power is less than the interference power, and particularly far less than the interference power (e.g., 20 dB to 40 dB less than the interference power), as will be become evident via this disclosure.

The DSA system can include a DSA receiver 108. The DSA receiver 108 can be a short-range receiver. The DSA receiver 108 can include a plurality of DSA antennas 110 and a DSA signal processing module 112. The DSA signal processing module 112 can be a software and/or hardware (e.g., processor) module. The DSA signal processing module 112 can be configured to perform canonical correlation analysis (CCA) on the complex signal. For instance, the DSA signal processing module 112 can be a processor in operative association with memory. The memory can have instructions (e.g., algorithms) stored thereon executable by the processor to carry out embodiments of the method disclosed herein.

As note herein, various components are part of a DSA system 100, a secondary communication system 104, and/or a primary communication system 102. The DSA system 100 components can be configured to communicate with or operate within a network defined by the secondary communication system 104 and/or a primary communication system 102. Thus, in addition to the components disclosed herein can include or be associated with antennas, processors, transmitters, receivers, transceivers, etc. to facilitate wireless communications. Any of the antennas discussed herein can be any device that, during transmission, receives electric current in the form of signals and radiates the energy from the electric current as electromagnetic waves. The antenna, during reception, receives electrical power of an electromagnetic wave signal (EM signal) to generate an electric current, which can be processed to derive signals therefrom. The antennas can also digitize the EM signal to generate digital data. Other components such as digitizers, switches, filters, receivers, amplifiers, etc. can be used to facilitate proper operation of the antenna. Any of the processors discussed herein can be hardware (e.g., processor, integrated circuit, central processing unit, microprocessor, core processor, computer device, etc.), firmware, software, etc. configured to perform operations by execution of instructions embodied in algorithms, data processing program logic, automated reasoning program logic, etc.

Any of the components can include, be part of, or be associated with a computing device. Use of computing devices can includes Graphics Processing Units (GPUs), Field Programmable Gate Arrays (FPGAs), other types of processing units, etc.

Any of the memory discussed herein can be computer readable memory configured to store data. The memory can include a non-volatile, non-transitory memory (e.g., as a Random Access Memory (RAM)), and be embodied as an in-memory, an active memory, a cloud memory, etc. Embodiments of the memory can include a processor module and other circuitry to allow for the transfer of data to and from the memory, which can include to and from other components of a communication system. This transfer can be via hardwire or wireless transmission.

Any of the transmitter-receiver pairs or transceivers discussed herein can be used in combination with switches, receivers, transmitters, routers, gateways, wave-guides, etc. to facilitate communications via a communication approach that facilitates controlled and coordinated signal transmission and processing to any other component or combination of components of the DSA system 100. The transmission can be via a communication link. The communication link can be electronic-based, optical-based, opto-electronic-based, quantum-based, etc.

In addition, any of the components can have an application programming interface (API) and/or other interfaces configured to facilitate a computer in communication with the DSA system 100 executing commands and controlling aspects of any one or combination of components. For example, an embodiment of the DSA system 100 can include, be part of, or be associated with a computer (e.g., a server, a mainframe computer, a desk top computer, a laptop computer, a tablet, a smartphone, smart watch, virtual reality device etc.) configured to be in communication with any one or combination of components of the DSA system 100. The computer can be programmed to generate a user interface configured to facilitate control of and display of various operational aspects of the DSA system 100, including operational aspects of any component of the DSA system 100, the primary communication system 102, and/or the secondary communication system 104.

Some embodiments include the secondary communication system 104 and/or the primary communication system 102. For instance, while the inventive system can consist of the DSA system 100 alone, some embodiments can include the DSA system 100 in combination with the secondary communication system 104. Some embodiments can include the DSA system 100 in combination with the primary communication system 102. Some embodiments can include the DSA system 100 in combination with the primary communication system 102 and the secondary communication system 104.

The primary communication system 102 can include at least one primary system transmitter 114 configured to communicate with at least one primary system receiver 116. The primary system receiver 116 can have at least one primary system antenna 118. With the disclosed method, the DSA system 100 can operate to facilitate signal transmission via the secondary communication system 104 in the presence of the primary communication system 102, the signal transmission being within the bandwidth of the primary communication system 102 channel, wherein the primary communication system receiver 116 only needs a single primary system antenna 118. As will be apparent from the present disclosure, the primary system receiver 116 can have more than one primary system antenna 118 but only one primary system antenna 118 is required.

The DSA system 100 includes at least one DSA transmitter-receiver pair (e.g., transceiver) for communicating via the secondary communication system 104. The number of DSA transmitter-receiver pairs is determined by the number of uses, as will be explained herein. Signal transmission between a primary system transmitter 114 and a primary system receiver 116 of the primary communication system 102 constitutes a primary use of spectrum within communication band B. At least one signal transmission between each DSA transmitter-receiver pair of the DSA system 100 constitutes a secondary use of spectrum within communication band B. The DSA receiver 108 of each DSA transmitter-receiver pair includes a number of DSA antennas 110 that is greater than or equal to the sum of primary and secondary uses.

In some embodiments, the DSA transmitter 106 can be configured to generate the second signal via a symbol repeat technique or a block repeat technique. As noted herein, the complex signal includes two signals, the second being a repeat of the first. Techniques for generating a repeated signal can include a symbol repeat technique, a block repeat technique, etc.

In some embodiments, the DSA transmitter 106 can be configured to generate a digitally-modulated signal of the complex signal. This can involve encoding a digital information signal into the amplitude, phase, or frequency of the transmitted signal.

In some embodiments, each DSA antenna 110 receives a signal transmission from a primary system transmitter 114 of the primary communication system 102 and a signal transmission from the DSA transmitter 106. The DSA signal processing module 112 can be configured to generate a matrix to mathematically model the complex signal. The matrix can have a number of columns equal to the number of DSA antennas 110 for each DSA receiver 108. As will be explained in greater detail later, an individual column can be made to correspond to a baseband-equivalent signal received from an individual DSA antenna 110 that is a sum of baseband signal transmissions weighted by complex coefficients modeling the respective propagation channels. With the model, the DSA signal processing module 112 can be configured to split the complex signal into data packet Y₁ and data packet Y₂. The DSA signal processing module 112 can be configured to detect the first signal of the complex signal via a CCA technique. For instance, the DSA signal processing module 112 can be configured to detect the first signal via a maximum variance formulation of CCA so as to determine a minimum distance between liner projections of Y₁ and Y₂. The DSA signal processing module 112 can be configured to identify a sample index from a sequence of data packets from the complex signal, determine a canonical correlation coefficient for each pair of data packets of the complex signal associated with a given sample index, and identify the sample index for which canonical correlation is maximum.

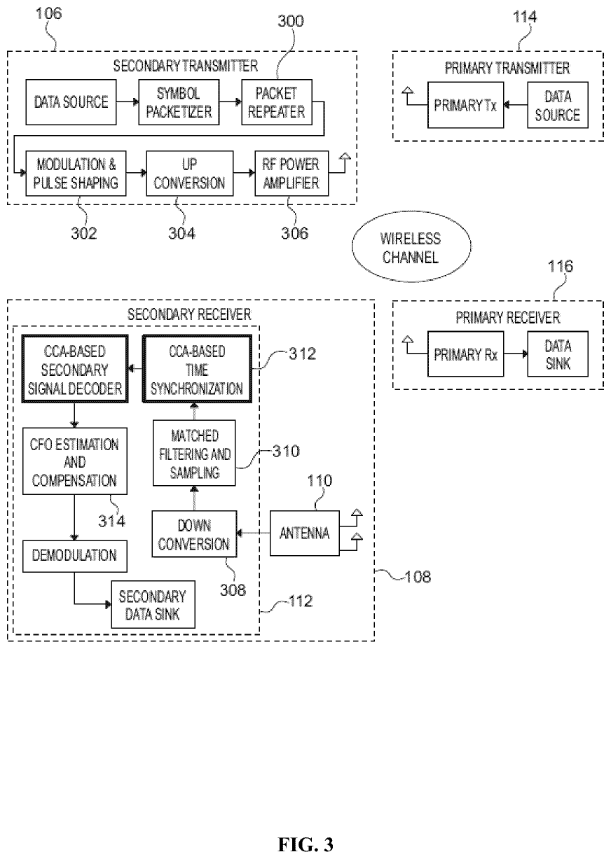

FIG. 3 shows an exemplary architecture block diagram of embodiments of primary and secondary communication systems 102, 104. The DSA system 100 can include a number of modules. Any of the modules be a software and/or hardware (e.g., processor) module in operative association with memory. The memory can have instructions (e.g., algorithms) stored thereon executable by the processor to carry out embodiments of the method disclosed herein.

As shown, an exemplary embodiment of the DSA system 100 can include a DSA transmitter 106 having a DSA data packet repeater module 300. The DSA data packet repeater module 300 can be configured to perform data packet repetition via a symbol repeat technique or a block repeat technique. The DSA transmitter 106 can be configured to generate a complex signal that includes a first signal and a second signal. The second signal can be a repeat of the first signal. The DSA system can include a DSA receiver 108 having a plurality of DSA antennas 110. The DSA receiver 108 can also include a DSA signal processing module 112. The DSA signal processing module 112 can be configured to perform canonical correlation analysis (CCA) on the complex signal.

FIG. 3 shows an exemplary DSA system 100 in which a data source sends a signal to a symbol packetizer, which transmits the signal to the DSA data packet repeater module 300 (e.g., the data source is coupled to the symbol packetizer and the symbol packetizer is coupled to the DSA data packet repeater module 300). The DSA data packet repeater module 300 can transmit the signal to a DSA modulation and pulse shaping module 302 (e.g., the DSA data packet repeater module 300 is coupled to the DSA modulation and pulse shaping module 302). The DSA modulation and pulse shaping module 302 can be used to change the waveform of transmitted pulses to make the transmitted signal better suited to its purpose or the intended communication channel. This can involve limiting the effective bandwidth of transmission. The DSA modulation and pulse shaping module 302 can transmit the signal to a DSA up conversion module 304 (e.g., the DSA modulation and pulse shaping module 302 is coupled to the DSA up conversion module 304). Up conversion can involve techniques to shift a transmission signal to a different wavelength (e.g., to a shorter wavelength). The DSA up conversion module 304 can transmit the signal to a DSA power amplifier module 306 (e.g., the DSA up conversion module 304 is coupled to the DSA power amplifier module 306) The DSA power amplifier module 306 can transmit the signal (e.g., the complex signal) to the DSA receiver 108.

Thus, the DSA transmitter 106 can include any one or combination of a data source, a signal to a symbol packetizer, a DSA data packet repeater module 300, a DSA modulation and pulse shaping module 302, a DSA up conversion module 304, or a DSA power amplifier module 306. The DSA transmitter can also perform functions related to generating the data source and symbol packetizing.

The exemplary DSA system 100 of FIG. 3 shows an exemplary DSA receiver 108. The DSA receiver 108 can receive the signal transmitted form the DSA transmitter 106, which is the complex signal discussed herein. The DSA receiver 108 includes at least two DSA antenna 110. The DSA antenna(s) 110 can transmit the signal to a DSA down conversion module 308 (e.g., the DSA antenna(s) 110 is/are coupled to the DSA down conversion module 308). Down conversion can involve techniques to shift a transmission signal to a different wavelength (e.g., to a longer wavelength). The DSA down conversion module 308 can transmit the signal to a DSA matched filtering and sampling module 310 (e.g., the DSA down conversion module 308 is coupled to the DSA matched filtering and sampling module 310). Matched filtering and sampling can involve correlating a known delayed signal with an unknown signal to detect the presence of a template in the unknown signal. The DSA matched filtering and sampling module 310 can alternatively be configured for convolving an unknown signal with a conjugated time-reversed version of a template.

The signal can then be further processed for time synchronization. For instance, the DSA matched filtering and sampling module 310 can transmit the signal to a DSA CCA based time synchronization module 312 (e.g., the DSA matched filtering and sampling module 310 is coupled to the DSA CCA based time synchronization module 312), wherein the DSA CCA based time synchronization module 312 performs CCA based time synchronization. This can involve CCA based signal decoding on the complex signal, which is explained in detail later. The DSA CCA based time synchronization module 312 can transmit the signal to a DSA carrier frequency offset (CFO) module 314 (e.g., the DSA CCA based time synchronization module 312 can be coupled to the DSA CFO module 314), wherein the DSA CFO module 314 performs post-CCA carrier frequency offset (CFO) and phase estimation and/or compensation prior to final symbol-level detection. Carrier frequency offset (CFO) can occur when a signal being processed via down-conversion does not synchronize with the carrier signal contained in the signal. This can occur due to frequency mismatch between the transmitter and the receiver oscillators and the Doppler effect if/when the transmitter/receiver moves relative to the receiver/transmitter, leading to a shift in frequency of the received signal. Accordingly, CFO estimation can be a key component in effective and efficient signal processing. With the inventive CCA method, CFO estimation can be performed by the DSA receiver 108. The signal can then undergo demodulation and data sink processing.

Thus, the DSA receiver 108 can include any one or combination of a DSA antenna 110, DSA signal processing module 112, a DSA down conversion module 308, a DSA matched filtering and sampling module 310, DSA CCA based time synchronization module 312, or a DSA CFO module 314. It is further understood that any one or combination of the modules discussed herein for the DSA receiver 108 can be part of or associated with the DSA signal processing module 112. The DSA signal processing module 112 can also perform functions related to demodulation and data sink processing.

Embodiments also include methods for providing dynamic spectrum access. The method can involve generating a complex signal for a secondary communication system 104. This can involve any of the techniques discussed herein. For instance, the complex signal can be within a communication band A that is equal to or falls within a communication band B of a primary communication system 102. The complex signal can include a first signal and a second signal that is a repeat of the first signal. The method can further involve performing CCA based time synchronization and/or CCA based signal decoding on the complex signal. Again, this can involve any of the techniques disclosed herein. Generating a complex signal comprising a first signal and a second signal that is a repeat of the first signal, and performing CCA based time synchronization and/or CCA based signal decoding on the complex signal allows for short-range communications to occur via the secondary communication system 104 in the presence of a primary communication system 102. This short-range communication can be transmitted within a communication band of the primary communication system 102 while minimally affecting the primary communication system 102 network's performance and without requiring any channel knowledge at the secondary communication system 104 network.

As can be appreciated from the present disclosure, the inventive system and method provides a practical underlay scheme that permits reliable low-power short-range secondary communication. The secondary transmitter merely has to send its signal twice, at very low power (e.g., a few dBs above the noise floor). The power can be greater than, equal to, or less than the primary's interference, but a particular advantage of the inventive system/method is using a secondary signal that has a power that is far below the primary's interference. Exploiting the repetition structure, reliable and computationally efficient recovery of the secondary signal is possible via canonical correlation analysis (CCA). Experiments using a software radio testbed reveal that, for a secondary user with only two receive antennas, reliable detection of the secondary signal is possible for signal to interference plus noise ratio (SINR) in the range of −20 to −40 dB. The approach works with unknown time-varying channels, digital or analog modulation, it is immune to carrier frequency offset, and provides means for accurate synchronization of the secondary user even at very low Signal Interference plus Noise Ratio (SINR).

The rapidly growing demand for wireless connectivity from 5G+ to Internet of Things (IoT) and WiFi-enabled devices has brought renewed interest and impetus behind dynamic spectrum sharing [2]-[4]. Even with millimeter-wave (mmWave) technology, the propagation loss in the 28 GHz 300 GHz bands is much higher than in the sub-6 GHz bands [5], making the latter better-suited for various wireless systems. The premium placed on sub-6 GHz bands together with the need to protect scientific uses in the mmWave bands are driving the renewed interest in spectrum sharing and dynamic spectrum access (DSA).

DSA techniques are designed to improve spectrum utilization by allowing secondary unlicensed users to take advantage of ephemeral transmission opportunities in space, time, or frequency [6]-[8]— a capability often referred to as cognitive radio. Currently, there are three widely used DSA techniques for cognitive radio networks (CRN): interweaving, overlay, and underlay [2]. In the interweaving mode, the secondary users search the band for spectrum holes (vacant sub-bands) which represent secondary transmission opportunities. The overlay paradigm requires tight coordination between the primary and secondary users, which complicates implementation. Relative to the interweaving and overlay modalities, underlay spectrum sharing is appealing in terms of its prioritization of the licensed/legacy users, practical feasibility, and its relative simplicity—there is no need for continuous spectrum sensing or tight coordination with the primary system.

There is a plethora of works on DSA and cognitive radio, spanning two decades of research ranging from spectrum sensing [9], [10] and channel gain “cartography” to different spectrum sharing modalities [12]-[24]. A common assumption in those works is that the signal to interference plus noise ratio (SINR) at the secondary receiver can be made high enough to enable reliable decoding. In practice, this is hard to ensure if the primary transmitter is powerful (e.g., a TV or radio station) while the secondary is power-limited (e.g., a WiFi or IoT device). Furthermore, many of these works are relying on assumptions that are hard to meet in practice—such as the availability of cross-channel knowledge at the secondary users.

Few spectrum underlay works have attempted to circumvent the need for such assumptions. One interesting recent example is [25], where the authors proposed a nice semi-blind beamforming-based underlay spectrum sharing approach, which allows the secondary users to access the spectrum while minimally affecting the primary network performance, without requiring any channel knowledge at the secondary network. However, the proposed method in [25] still requires i) the primary communication to be bidirectional (which does not hold for legacy radio/TV broadcast, or scientific uses); ii) the flow direction of primary traffic to be predictable; iii) effectively time-invariant channels from/to the primary users; and iv) training pilots for designing a beamformer at the secondary receiver. These are still restrictive assumptions. In particular, the reverse transmission of the primary user needs to be synchronized with the forward of the secondary, and vice versa, so the secondary users need to track which node is transmitting in the primary network.

The present disclosure, however, demonstrates that it is possible to design an underlay strategy that enables reliable decoding at very low SINK and modest SNR at the secondary receiver, without noticeable increase of the noise floor at the primary receiver. It is also possible to do this seamlessly, without any coordination between the primary (legacy/incumbent) and the secondary user.

The present disclosure provides a secondary transmission protocol that operates at very low power yet allows reliable secondary communication without requiring any channel knowledge or coordination with the primary system. This can be achieved by the secondary user sending its signal twice, each time at very low power. Assuming that the secondary receiver employs at least two receive antennas, the transmission protocol allows the secondary receiver to create two “views” of the signal space that only share the secondary signal—the interference from the primary network is potentially very strong, but different in the two views. Invoking canonical correlation analysis (CCA) on these two views, the secondary receiver can reliably decode its intended signal under very strong interference from the primary user.

Transmitting the same signal twice can be viewed as repetition coding [26], or as elementary direct-sequence spreading [27], [28] with spreading gain equal to two. The approach disclosed herein is fundamentally different from these classical techniques in the way that this controlled redundancy is exploited at the receiver (i.e., on the “decoding” side), where we leverage the unique strengths of CCA. CCA is a well-known statistical learning tool that seeks to find linear combinations of two random vectors such that the resulting pair of random variables is maximally correlated [29]. Recent work [30] developed a broadly useful algebraic interpretation of CCA as a method that identifies a common (shared) subspace between two signal views, even under strong interference from individual (per-view) components. CCA has found many other applications in signal processing and wireless communications, including direction-of-arrival estimation [31], equalization [32], radar [33], [34], blind source separation [35], [36], and more recently cell-edge user detection [37], [38], and multi-view learning [39]-[41], to name a few.

In summary:
A secondary underlay framework is disclosed that enables seamless primary-secondary coexistence—there is no need for coordination between the two. Assuming that the secondary receiver is equipped with two receive antennas and down-conversion chains, simple repetition of the secondary signal coupled with CCA processing at the secondary receiver can recover the secondary transmission even at very low SINR.
The approach is data-driven and unsupervised in that it directly recovers the secondary information signal (up to complex scaling), without requiring channel state information or primary signal recovery and cancellation. It even works with analog modulation of the primary and/or the secondary signal.
Time-varying channels for the primary and the secondary user can be naturally accommodated, provided that the channel coherence time is greater than half the secondary transmission frame length (comprising a transmitted packet and its repetition—and the packet length is up to our control and can be fairly short).
From a computational point of view, what is required is the computation and inversion of small correlation matrices, and then a principal eigenvector computation, which can be done using e.g., the power method. Hence, the approach is attractive for practical implementation.
The approach is immune to carrier frequency offset, which can be compensated after the secondary symbol sequence is extracted using CCA. Furthermore, exploiting the repetition structure and CCA, a matching synchronization algorithm is developed and utilized that identifies the correct timing of the secondary transmission frames even at very low SINR in an unsupervised manner—i.e., without using any pilot symbols, only exploiting the structured redundancy introduced by repetition. These side-benefits are very fortunate, for otherwise synchronization is a very difficult problem at very low SINR without very long pilot sequences for acquisition.
In order to demonstrate the practical feasibility and merits of the approach, disclosed are results of a testbed a prototype using software defined radios, where both the secondary and primary users were realized using USRP-2920 radios. Multiple experiments were conducted to evaluate the performance of the underlay CCA approach under realistic conditions. Laboratory experiments verified that the approach can reliably recover a secondary user signal that is buried under strong interference from the primary system (SINK as low as −40 dB), and that it approaches the attainable detection performance in the interference-free regime (where the primary user is idle).

Overview of CCA

Consider two data sets Y₁=[y₁⁽¹⁾, . . . , y₁^{(N)}]∈ [symbol] ^{M}^{₁}^{×N} and Y₂=[y₂⁽¹⁾, . . . , y₂^{(N)}]∈ [symbol] ^{M}^{₂}^{×N}, where [symbol] represents the n-th realization of the random vector y [symbol] associated with the [symbol] -th view, [symbol] ∈{1, 2}. We assume without loss of generality that all the data vectors { [symbol] }ₙ₌₁^{N} in each view are zero-mean, otherwise the sample mean can be subtracted as a pre-processing step.

In its simplest form, CCA aims to find two linear combinations of the elements of random vectors y₁ and y₂, z₁=q^{H}y₁ and z₂=q^{H}y₂, respectively, such that the two derived random variables z₁ and z₂ are maximally correlated, where (·)^{H} denotes conjugate transpose. In that sense, CCA seeks to find a “latent” component that is common between the two random vectors. From an optimization perspective, the CCA problem can be posed as [29], [42],

$${max}_{{q}_{1} , {q}_{2}} Re \{ {q}_{1}^{H} {Y}_{1} {Y}_{2}^{H} {q}_{2} \} \qquad ( 1 a )$$

$$s . t . {q}_{ℓ}^{H} {Y}_{ℓ} {Y}_{ℓ}^{H} {q}_{ℓ} = 1 , ℓ ∈ \{ 1 , 2 \} , \qquad ( 1 b )$$

where Re{·} extracts the real part of its argument. Notice that the scaling constraints serve to exclude the trivial (and meaningless) all-zero solution. An appealing feature of CCA that renders it suitable for practical implementation is that (1) admits an algebraic solution via eigendecomposition [42]. In particular, the optimal canonical vectors can be obtained via first solving the following generalized eigenvalue problem to obtain q₁* and λ*

R₁₂R₂⁻¹R₂₁q₁=λR₁q₁. (2)

where

$${R}_{i} = \frac{1}{N} {Y}_{i} {Y}_{i}^{H}$$

is the sample auto-covariance of the random vector yᵢ, and

$${R}_{ij} := \frac{1}{N} {Y}_{i} {Y}_{j}^{H}$$

is the sample cross-covariance of the two random vectors yᵢ and yⱼ, respectively, for i, j=1, 2 and i≠j. Further, it can be easily verified that the term λ* represents the square of the correlation coefficient, ρ(q₁*, q₂*), associated with the optimal canonical pair q₁* and q₂* where

ρ(q₁*,q₂*)=Re{q*₁^{H}Y₁Y₂^{H}q₂*}. (3)

Once the optimal q₁* and λ* are obtained from solving (2), the optimal q₂* can be obtained via direct substitution in the following

$${q}_{2}^{*} = \frac{1}{\sqrt{{λ}^{*}}} {R}_{2}^{- 1} {R}_{21} {q}_{1}^{*} . \qquad ( 4 )$$

A more intuitive formulation of (1) (that also happens to be more convenient for our purposes) is to minimize the distance between the linear projections of Y₁ and Y₂ on q₁ and q₂, respectively. That is [42], [43],

$${min}_{{q}_{1} , {q}_{2}} {‖ {Y}_{1}^{H} {q}_{1} - {Y}_{2}^{H} {q}_{2} ‖}_{2}^{2} \qquad ( 5 a )$$

$$s . t . {q}_{ℓ}^{H} {Y}_{ℓ} {Y}_{ℓ}^{H} {q}_{ℓ} = 1 , ℓ = \{ 1 , 2 \} \qquad ( 5 b )$$

Expanding the cost of problem (5) and using the constraints, the equivalence between (1) and (5) can be easily verified. Throughout this work, we will focus on the distance minimization formulation of CCA.

In what follows, we will see how judicious design of the secondary signaling protocol can be used to leverage the power of CCA to enable simultaneous and fully independent operation of two coexisting systems without affecting each other's performance.

System Model

Consider an underlay cognitive radio network comprising a secondary transmitter (STx) communicating with a secondary receiver (SRx) equipped with Mₛ≥2 antennas, in the presence of a primary transmitter (PTx) and primary receiver (PRx) with Mₚ≥1 antennas, as shown in FIG. 1. Multiple secondary and primary users can also be accommodated as we will explain later. Let hₛ∈ [symbol] ^{M}^{ₛ}, hₚₛ∈ [symbol] ^{M}^{ₛ}, hₛₚ∈ [symbol] ^{M}^{ₚ} and hₚ∈ [symbol] ^{M}^{ₚ} be the channel response between the STx and SRx, PTx and SRx, STx and PRx, and PTx and PRx, respectively, defined as

hₛ=\sqrt{σₛ}gₛ, hₚₛ=\sqrt{σₚₛ}gₚₛ,

hₚ=\sqrt{σₚ}gₚ, hₛₚ=\sqrt{σₛₚ}gₛₚ, (6)

where gₛ, gₚₛ, gₛₚ, and gₚ are the respective small-scale fading vectors, while the terms σₛ, σₚₛ, σₛₚ, and σₚ are the corresponding large scale fading coefficients with values dependent on the propagation distance and environment.

Unlike prior works [15]-[19] that require estimates of the cross channels hₚₛ and/or hₛₚ at the secondary receiver and the secondary transmitter, respectively, this paper considers a practical setting where the secondary users have no knowledge about any channel state information in the network.

Signal Model

We assume that the primary user's transmission is done over a narrowband channel of bandwidth B Hz. This could be a frequency tone of an orthogonal frequency division multiplexing (OFDM) system, in the case of multicarrier transmission. For simplicity of exposition, we assume that both users are employing QPSK modulation, but other types of modulation can be accommodated. The basic approach we use to recover the secondary signal is modulation-agnostic, and does not assume anything about the primary signal's modulation, which can even be analog.

Let xₚ∈ [symbol] ^{N} and xₛ∈ [symbol] ^{N} denote the digitally-modulated transmitted signal by the primary and secondary user, respectively, where |xₚ(n)|²=1 and |xₛ(n)|²=1 for n∈[N]:={1 . . . , N}. In writing down the discrete-time baseband-equivalent model, we shall assume, for simplicity of exposition, that the primary and secondary signals are synchronized at the symbol level—otherwise writing down the model is cumbersome. However, such an assumption is not required for our approach to work, and we shall later present an algorithm that can lock on the secondary user signal at the SRx. All our laboratory experiments are concerned with this asynchronous setup.

The discrete-time synchronous baseband-equivalent model of the received signal, Yₛ∈ [symbol] , at the secondary receiver is given by

Yₛ=\sqrt{αₛ}hₛx_{g}^{T}+\sqrt{αₚ}hₚₛxₚ^{T}+Wₛ, (7)

where αₛ and αₚ are the transmit power of the STx and PTx, respectively. The term Wₛ∈ [symbol] represents noise and it contains independent identically (i.i.d) distributed elements with each entry drawn from a complex Gaussian distribution with zero mean and variance σₛ². Similarly, the received signal at the primary receiver, Yₚ∈ [symbol] , is given by is given by

Yₚ=\sqrt{αₛ}hₛₚxₛ^{T}+\sqrt{αₚ}hₚxₚ^{T}+Wₚ, (8)

where Wₚ∈ [symbol] is the noise term at the primary receiver with i.i.d entries drawn from a complex Gaussian distribution with zero mean and variance σₚ².

One goal of this work is to show that, in the absence of channel state information at the STx/SRx and without any coordination between the primary and secondary users, seamless secondary underlay communication is possible without affecting the primary network performance. To do this, we will first present a simple secondary transmission protocol together with a data-driven (unsupervised learning-based) approach that allow i) the STx to transmit its signal at very low power so that it does not affect the detection performance at the PRx, thereby keeping the resulting interference close to the PRx noise floor (the PRx can reliably decode its signal even with one receive antenna), and ii) the SRx to reliably decode its intended signal at significantly low SINR (e.g., −40 dB).

Secondary Transmission Protocol

In this section, we will present a simple transmission protocol that will assist the secondary transmitter to reliably communicate with its receiver over the same channel occupied by the primary network, and without degrading the primary user's performance.

The secondary transmission scheme is described as follows. If a secondary user desires to transmit in a channel occupied by a primary user, it simply transmits the same sequence twice at very low power—enough to be received above the thermal noise floor at the SRx, but far below what is required to be directly decoded in the face of possibly overwhelming interference by the PTx. The repetition of the secondary user's sequence can happen at the symbol or block level; we assume block-repetition for simplicity of exposition. To do this, we write xₛ as two back-to-back repeated blocks, i.e., xₛ=[s^{T}s^{T}]^{T}, where s∈C^{N/2} is the transmitted QPSK symbols by the secondary user over each block. Partitioning xₚ=[p₁^{T}p₂^{T}] in two blocks for convenience, the received signal at the secondary receiver in (7) can be rewritten as

$$\text{?} = {\text{?} [ \text{?} ]}^{T} + \text{?} , \qquad ( 9 )$$

$$\text{?} \text{indicates text missing or illegible when filed}$$

where Hₛ is an Mₛ×2 matrix that holds on the first column the channel vector containing the channel coefficients between the STx and SRx, Hₛ, and on the second column the channel from the PTx to the SRx, hₚₛ. Notice that the transmit power terms of both the STx and PTx have been absorbed in the respective channel vectors, for brevity.

As noted earlier, the transmission scheme can be interpreted as repetition coding [26], or equivalently as direct-sequence spreading of the secondary user's transmission with spreading gain equal to two [27]. Treating this situation as CDMA or as an error control problem will not work, because the primary user dominates the received signal, and small spreading/coding gains cannot make up for the large power difference between the secondary and primary user. CDMA performance is known to suffer from the so-called near-far problem which is clearly the case for the setup considered herein.

We will next present a low-complexity learning-based approach that allows the SRx to reliably decode its intended signal, s, even if the received SINK is significantly low.

Secondary Signal Detection Via CCA

By exploiting the repetition structure, the SRx can split Yₛ and Wₛ into two blocks, Yₛ=[Y₁ Y₂], and Wₛ=[W₁ W₂], for which we have

Y₁=Hₛ[sp₁]^{T}+W₁, (10)

Y₂=Hₛ[sp₂]^{T}+W₂ (11)

Now, given the two signal views in (10), CCA will be invoked to show that reliable detection of the second signal, s, is possible even at low SINR. To see how we can utilize CCA to identify the secondary signal, s, from Y₁∈ [symbol] ^{M}^{ₛ}^{×N/2} and Y₂∈ [symbol] ^{M}^{ₛ}^{×N/2}, we will use the so-called maximum variance (MAX-VAR) formulation of CCA [42]. That is

$${min}_{g , {q}_{1} , {q}_{2}} {\sum }_{ℓ = 1}^{2} {‖ {Y}_{ℓ}^{T} {q}_{ℓ} - g ‖}_{2}^{2} , \qquad ( 12 a )$$

$$s . t . {‖ g ‖}_{2}^{2} = 1. \qquad ( 12 b )$$

The MAX-VAR formulation is equivalent to the distance minimization in (5), since it can be shown that both formulations yield the same optimal solutions q₁* and q₂*. The MAX-VAR formulation seeks to find a direction g∈ [symbol] ^{N/2} that is maximally correlated after the linear projections of Y₁ and Y₂ on q₁∈ [symbol] ^{M}^{ₛ}∈CMs and q₂∈ [symbol] ^{M}^{ₛ}, respectively.

In a recent work [37], we have shown that given two multi-antenna signal views that include one shared (common) component and multiple individual (“private”, not shared) components in each view, CCA can efficiently extract the common component up to scaling ambiguity no matter how strong the individual components are. One can see from the two signal views in (10) that each block (view) is subject to strong interference by the primary user, but, in general, the interference is different in the two blocks—thus there is a unique common subspace, namely (the span of) s that conveys the secondary transmission. Building upon our theoretical findings in [37], we will next show that our CCA interpretation applies, and under very mild conditions will recover s up to scaling, even if xₚ is several orders of magnitude stronger than xₛ.

The following theorem, which is a slight modification of the results of [30], states the conditions for identifying the secondary transmitted signal s at the SRx.

Theorem 1. In the noiseless case, if the matrices Bl [symbol] :=[s, p [symbol] ]∈ [symbol] ^{N/2×2}, for [symbol] ∈{1, 2}, and Hₛ∈ [symbol] ^{M}^{ₛ}^{×2}, and are full column rank, then the optimal solution g* of problem (12) is given by g*=γs, where γ∈ [symbol] , γ≠0 is the scaling ambiguity.

Proof. The proof is provided in Theorem 1 in [37].

Note that the full rank condition on the matrices [symbol] needs the signals s and [symbol] to be linearly independent which is practically always the case for any reasonable “packet” length N, because these signals are drawn from statistically independent sources. On the other hand, the full rank condition on Hₛ is in fact the more restrictive one as it requires i) the number of antennas at the SRx to be greater than or equal to the number of co-channel signals (two in our exemplar setting) and ii) the channel vectors to be linearly independent. The latter is realistic, these being statistically independent channel vectors from the PTx and the STx to the SRx.

Time-varying Channel Directions, Fading, and Intermittent Transmissions.

Although the two signal views in (10) implicitly assume that the channel is constant across the two secondary repetition blocks, the method in fact can work even if the two channel matrices are different [37]. Therefore, with block repetition, the coherence time needs to be only greater than one block duration. We will see in the experiments how this feature grants our method robustness against time varying channels.

Interference Cancellation

It is worth pointing out that if the primary user signal is order(s) of magnitude stronger and the primary channel remains constant (no intermittent transmissions, no time-division duplex, insignificant channel direction changes) then one can cancel the primary interference by simply projecting the received signal on the minor left singular vector of the matrix [symbol] , thereby “revealing” the secondary transmission. This can only work when the spatial channels are time-invariant. In practice, the channel gains fluctuate over time, and even if the average secondary signal to interference ratio is low (e.g., −40 dB), there are times when it becomes relatively high (e.g., −20 dB). These fluctuations quickly degrade the subspace estimate, leading to complete failure to detect the secondary signal, as we will see in the laboratory experiments.

Multiple Secondary Users

Note that our results dictate that our CCA approach can identify the secondary signal in a network with only one secondary user, and we have argued that finding the secondary user signal is tantamount to solving for a principal eigenvector which can be cheaply computed via the power method. Even with multiple secondary users, our recovery claim holds and receiver complexity is roughly the same, provided that i) each secondary receiver has enough antennas (as many as the maximum number of active users at any given time, see Theorem 1); and ii) there are no persistent and perfectly aligned collisions between any of the secondary users. In other words, no two secondary users transmit their packet pairs at the exact same times. With asynchronous wake-up type devices serving intermittent communication needs, this situation is highly likely.

Secondary Synchronization

One critical issue that we always face in practice is synchronization. The overall synchronization task comprises time, carrier frequency offset (CFO), and phase synchronization. While effective solutions to these problems are well-established for classical communication modalities, here we are dealing with a secondary signal that is potentially buried under the primary one, which makes secondary time synchronization and CFO acquisition much more challenging.

A standard receiver will naturally lock on the primary user, which means that the secondary signal will present itself with an unknown CFO and unknown start time within the received sequence. Fortunately, the presence of CFO does not destroy the alignment of the two copies of the secondary packet: owing to the temporal shift invariance property of pure complex exponential signals, the second copy is the same as the first except for a complex phase shift. Hence we can proceed with CCA and correct the CFO after recovering the CFO-modulated secondary packet. On the other hand, secondary timing acquisition is a challenge, due to the large power imbalance between the primary and the secondary signal. To deal with this problem, we developed a blind CCA-based algorithm that is practically effective in finding the start time of the secondary packet under such a large power imbalance between the two users.

In practice, the secondary receiver receives a long sequence, \tilde{Y}ₛ∈ [symbol] where Ñ>N. The goal is to find the sample index, k, so that we can extract the desired signal Yₛ from \tilde{Y}ₛ, and then use the method discussed above to decode the secondary user signal.

By exploiting the repetition structure of the transmitted signal, we start with k=1 and construct the two views Y₁^{(k)}=\tilde{Y}ₛ(;, k:N/2+k−1) and Y₂^{(k)}=\tilde{Y}ₛ(:, N/2+k:k+N−1) followed by solving (2) to obtain the associated correlation coefficient ρₖ (We use MATLAB notation, i.e., X(k)=X(:, k:N+k−1) contains all the rows of matrix X and a subset of columns of X starting from the k-th column and ending with the (N+k−1)-th column). Then, we store ρₖ, set k=k+1 and repeat the previous procedure. If we hit the start point of the two copies of the same packet, then CCA of these “views” will yield its maximum correlation coefficient. In other words, the correlation coefficient, ρₖ defined in (3), associated with each pair of canonical directions q₁^{(k)} and q₂^{(k)} obtained by solving (5) at the k-th step, will be at its maximum only when we have all the N/2 symbols in both views. This is because the secondary information sequence is uncorrelated, thus even if k is off by one, the two partial sequences will decorrelate. The higher N is, the higher the correlation peak we obtain as we will see in the experiments, but even moderate N, in the order of 128 symbols, can yield very good detection performance. Notice that the procedure utilizes the special frame structure that is designed to enable CCA, but is otherwise agnostic to the specific information sequence that is being sent by the secondary transmitter. In this sense, it is a blind synchronization strategy that leverages the power of CCA to enable reliable timing acquisition at very low SINR. The procedure is summarized as Algorithm 1.

Algorithm 1 Secondary Synchronization

Input: \tilde{Y} [symbol] ∈ [symbol] ^{M}^{₁}^{×Ñ},
Initialization: k = 1,
while k ∈ [Ñ − N + 1] do
| Construct Y₁^{(k)} = \tilde{Y} [symbol] (:, k : N/2 + k − 1) and Y₂^{(k)} = \tilde{Y} [symbol] (:, N/2 + k : k + N − 1)
| Compute ρₖ after solving (5) using Y₁^{(k)} and Y₂^{(k)}
| Store (k, ρₖ) in a stack
| Set k := k + 1
end
Selection: pick the k* := maxₖ ρₖ. [symbol]
indicates data missing or illegible when filed

The computational complexity of Algorithm 1 is determined by the complexity of solving a series of CCA problems, which is equivalent to solving for the principal component (canonical pair) of (2) a number of times (equal to the search window size). The canonical pair can be cheaply computed via a power iteration. Further, each CCA problem requires inversion of correlation matrices of size Mₛ×Mₛ each—these inverses can be computed analytically since Mₛ=2. To minimize the search window length, one can start with a coarse estimate for the region with high correlation coefficient and then do a narrow search within a small window size to get the final start time index, as we will see in the experiments. Furthermore, if the secondary transmitter is continuously transmitting, we do not need to run the full Algorithm 1 for each received packet—we only need to do a narrow timing search to compensate for jitter.

### EXPERIMENTS

In this section, we evaluate the performance of the CCA approach for low-power secondary underlay communication in practice (for simplified simulations, see [1]). To do so, we have built a prototype of the CCA underlay scheme using software defined radios (SDR).

### Experimental Setup

Both the primary and secondary links are realized using USRP-2920 devices and general purpose computers. The USRPs are used for radio signal transmission/reception, while the computers are used for baseband signal processing. The experimental layout includes use of five USRPs: one for the primary transmitter, one for the primary receiver, one for the secondary transmitter, and two for the secondary receivers. Each USRP is equipped with a single antenna. The two USRPs of the secondary receiver are connected together with a MIMO cable to synchronize the two receive radio frequency chains.

The locations of the PTx, PRx, STx, SRx are fixed throughout the experiments. The distances between the PTx and PRx, PTx and SRx, STx and PRx, and STx and SRx are 5, 3, 4.5, and 4 meters, respectively. The transmit power of the PTx is set to the maximum possible value, as shown in Table I unless stated otherwise, while the transmit power of the STx is adjusted for low-power secondary transmission. The sampling rate for both users is set to 1 Mega samples per second (MS/sec), the signal bandwidth is 100 KHz, and the carrier frequency is 1.2 GHz. The PTx uses a block of 256 QPSK symbols and the STx uses repetition over two blocks, each of length 128 QPSK symbols. The parameter settings for our experiments are summarized in Table I.

Signal Processing at the Transmitters.

At each Tx, the constructed block is oversampled by a factor of 10, then the resulting oversampled signal is pulse-shaped using a square-root raised cosine (SRRC) with roll-off factor and amplitude set to 0.5 and 6, respectively. The pulse shaped signal is zero-padded with a number of zeros equal to one third of the packet, yielding a sequence of length 4020 samples. This results in a transmission rate of 128 Kbps for the primary user and 64 Kbps for the secondary user. The zero-padding (used to emulate intermittent packet transmission) is also used at the receiver side to measure the received SNR and SINR, as we will see later. Symbol generation, up-sampling, and pulse shaping are done in MATLAB. Then, the transmit data of each user is fed to GNU radio before being transmitted over the air.

Secondary Receiver.

We use the CCA algorithm discussed above to detect both the secondary packet and the start of the 256×2 complex signal. After SRRC matched filtering, down-sampling to the symbol rate, and secondary synchronization, we construct the two signal views by separating the two back-to-back blocks, and then use CCA to recover the secondary signal. After solving the CCA problem (5), we average the two soft estimates of s obtained via Y₁^{H}q₁ and Y₂^{H}q₂, before hard thresholding.

TABLE I
Parameter settings for the experiments.

| Parameter | Primary | Secondary |
|---|---|---|
| Bandwidth (KHz) | 100 | 100 |
| Carrier frequency (GHz) | 1.2 | 1.2 |
| Modulation | QPSK | QPSK |
| Sample rate (MSps) | 1 | 1 |
| Maximum transmit power (dBm) | 20 | −15 |
| Number of antennas | 1 Tx, 1 Rx | 1 Tx, 2 Rx |
| Number of symbols | 256 | 128 |
| Oversampling factor | 10 | 10 |
| Number of packets | 2000 | 2000 |

To benchmark the performance of the CCA approach, we use the following baselines.

SVD without interference: we will use the singular value decomposition (SVD) to estimate the channel direction during a period when the primary user is inactive, i.e., there is no interference from the primary user. To do that, we first exploit the repetition structure to construct the signal Y=[Y₁^{T}Y₂^{T}]^{T}∈ [symbol] ^{M}^{ₛ}^{×N/2}. Then, the secondary user signal can be estimated by projecting the received signal Y on the left principal vector. Note that our use of the SVD “baseline” without interference (which is more appropriately called an “oracle” method here) is purely to show how well the method works—close to an oracle which operates in a fictitious interference-free environment.

SVD with interference: we will use SVD to project away the interference subspace by projecting on the third principal component of the matrix Y to estimate the secondary signal. Notice that projecting on the first two components yields the subspace containing the primary user signals, p₁ and p₂.

In order to resolve the scaling ambiguity that is inherent both in the CCA method and the SVD-based baselines, we assume that the first four secondary symbols are known at the SRx. Note that these symbols can be drawn from the packet header that contains the STx identification sequence.

It is worth noting that for the second baseline (SVD with interference), we use our blind method disclosed herein to recover the secondary packet start time index at the SRx, thereby giving a big advantage to the SVD based method. The typical synchronization method that would be used with SVD is to allow the STx to transmit a long pilot sequence, long enough to make up for the large power difference between the two users. Then, we would use knowledge of this pilot sequence at the SRx to find the start time index of the secondary signal via cross-correlation/matched filtering. This would seriously reduce the transmission rate of the secondary user relative to our blind method, especially for the setting considered herein where the secondary user is much weaker than the primary. Further, and perhaps worse, such training-based timing recovery requires the SRx to estimate the secondary CFO before (or together with) timing synchronization, which is in another serious complication given the low SINR and moderate SNR of the secondary user.

Primary Receiver.

At the PRx, we use energy detection for the primary packet detection. Then, we use primary training symbols to detect the start index of the 256×1 received signal of the primary user. To decode the primary symbols, we use 10 training pilots to estimate the primary channel coefficient and then do the hard detection of the equalized signal.

TABLE II
Estimated secondary SINR at the SRx over the two receive channels,
across the different transmit power imbalance scenarios.
The measured average secondary SNR is around 8 dB.

| | Tx power difference (dB) | | | | |
|---|---|---|---|---|---|
| | 20 | 25 | 30 | 35 | 40 |
| SINR (1^{st} antenna) | −17.1213 | −20.1632 | −27.1965 | −29.1996 | −32.2388 |
| SINR (2^{nd} antenna) | −15.1248 | −18.1909 | −25.2433 | −30.2522 | −31.2015 |

Performance Evaluation

Since we assume digitally-modulated signals for both users, we will use the symbol error rate (SER) as a performance metric (but recall that our method can also work with analog modulation for the primary and the secondary user).

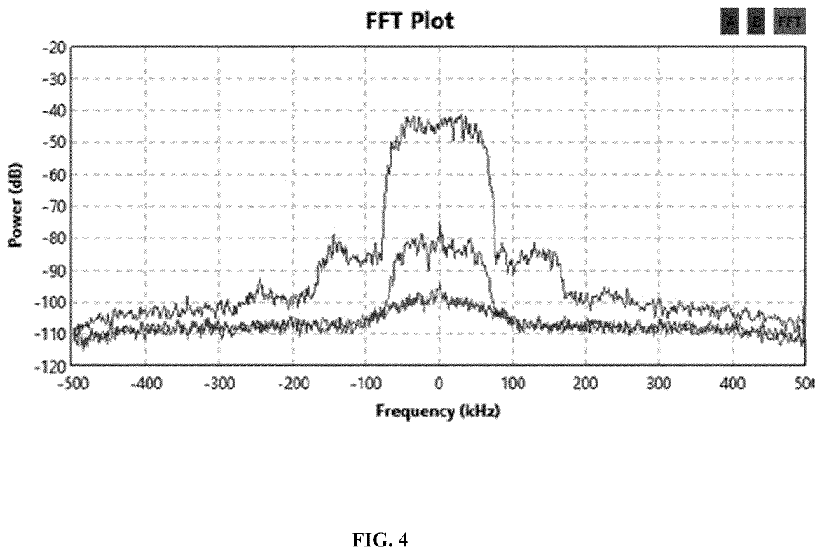

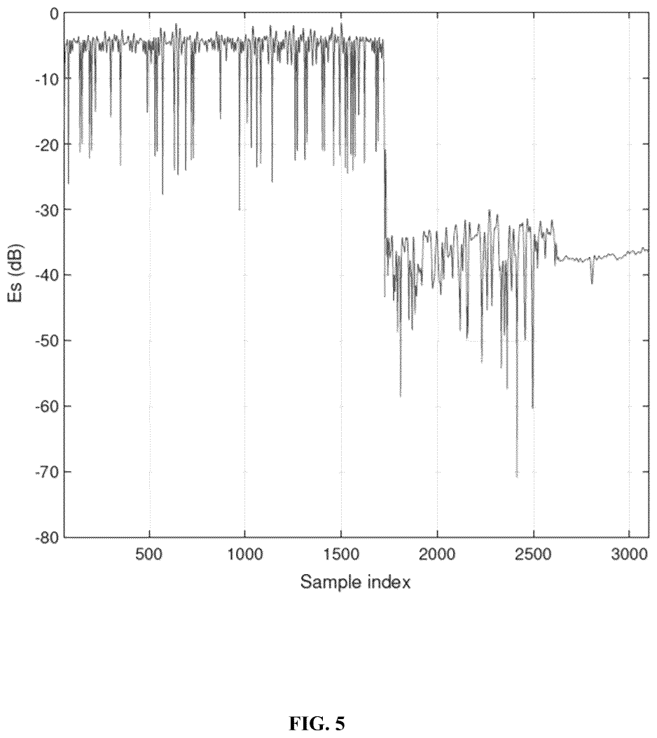

In the first experiment, we test the performance of the approach under different levels of primary interference at the secondary receiver. To do so, we fix the secondary transmit power to −18 dBm. This makes the corresponding measured average received SNR at the SRx equal to approximately 8 dB. We vary the primary transmit power from 0 to 20 dBm in 5 dB steps, thus generating transmit power differences from approximately −20 dB down to a rather extreme −40 dB. To validate the power difference between the two users at the SRx, FIG. 4 shows the GNU radio spectrum analyzer at the SRx with the received signal strength level of the PTx and STx in addition to the noise level. The transmit power of the PTx is set to 20 dBm, and FIG. 4 shows close to 40 dB power difference between the two users. Furthermore, FIG. 5 depicts the squared samples of one of the received packets at the SRx after matched filtering with the SRRC, for primary transmit power set to 15 dBm. It is clear that part of the secondary transmitted packet overlaps with the padded zeros of the primary packet, showcasing the power difference between the two users. Further, the remaining zeros show the low received SNR range of the secondary user.

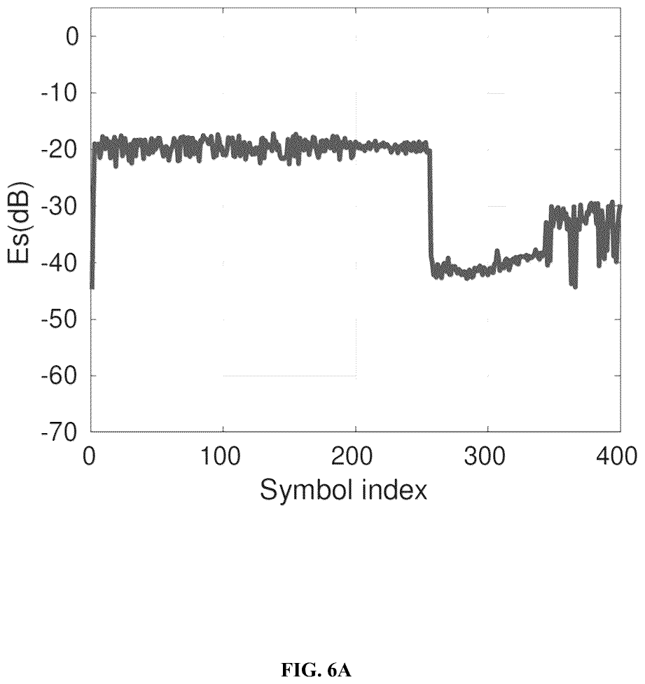

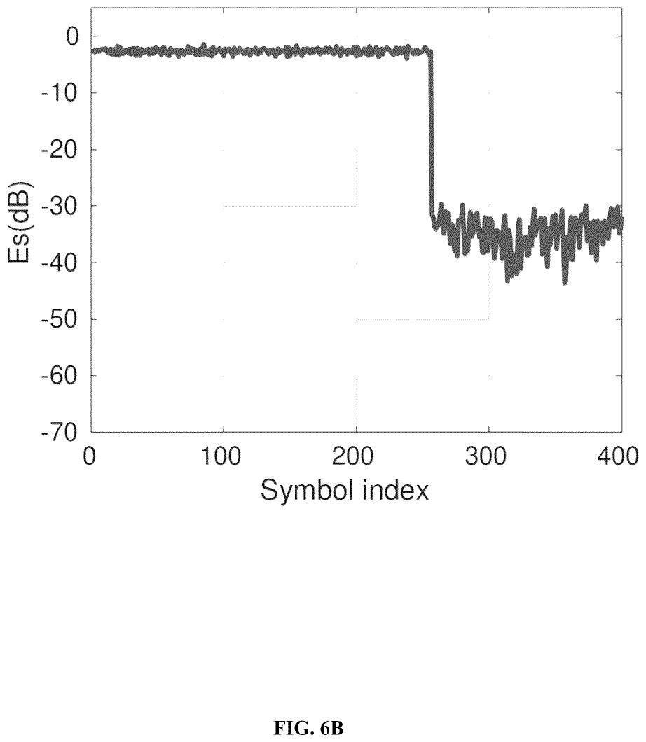

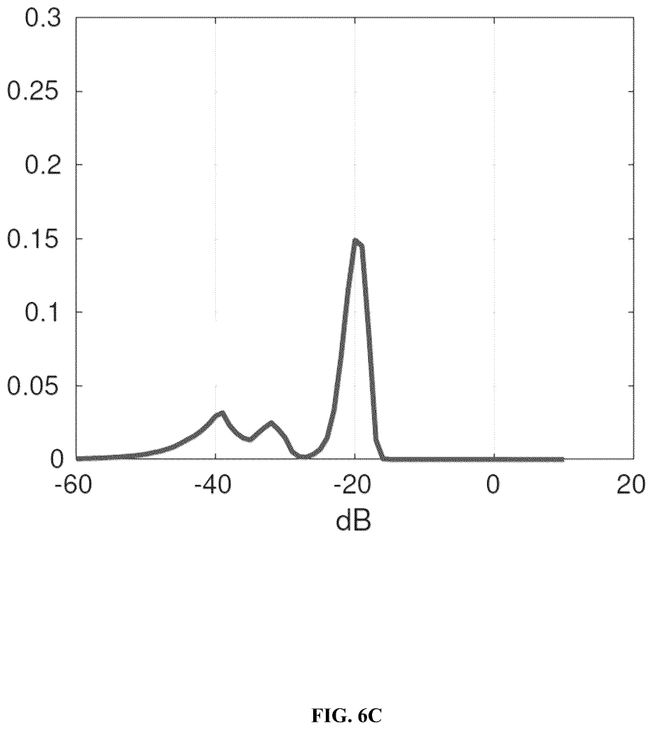

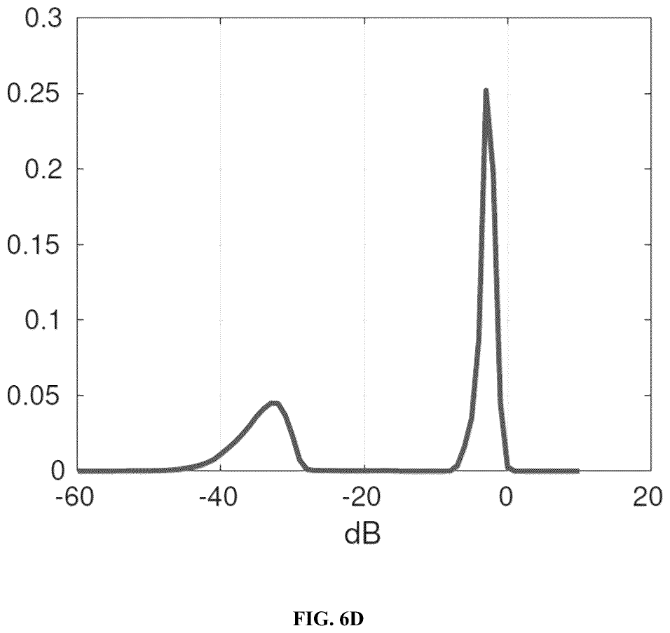

To compute the received SNR and SINR of the secondary signal at the SRx, we exploit the padded zeros in both the primary and secondary signals to measure the noise power, the secondary signal power, and the primary signal power at the SRx. In particular, we estimate the probability distribution of the symbol energy across 1500 packets, each of length 400 symbols. From the distribution, one can estimate either two peaks or three peaks, depending on the overlap between the secondary (primary) and the zeros of the primary (secondary). For instance, FIG. 6A clearly shows one of the received packets in one of the channels for the 20 dB transmit power imbalance case. One can clearly see the three different energy levels: one for the (primary, secondary and noise), another for (secondary and noise), and one for noise only. Notice that the first level can also be primary and noise, but since the primary is very strong, treating the first level as (primary and noise) or (primary, secondary and noise) will have negligible impact on the SINR and SNR measurements of the secondary user. FIG. 6C, shows the histogram of the collected data across 1500 packets for the 20 dB transmit power difference, where three distinct peaks are observed. In FIG. 6B, however, one can see a complete overlap between part of the secondary signal and the padded zeros of the primary user for the 40 dB transmit power difference, and hence, only two peaks can be seen in the distribution shown in FIG. 6D.

We use the data collected for the 20 dB transmit power difference to measure the energy levels corresponding to the three observed probability density peaks, see FIG. 6C. We use these values to solve a system of linear equations (three equations in three unknowns) to compute the received SNR and SINR at the secondary receiver. We repeat the same procedure for the different transmit power difference cases to calculate the associated SINR and SNR values. Note that, since the secondary transmit power is fixed throughout this experiment, we observed approximately the same average energy level (peak value) for either the noise level or the (secondary and noise) level, across all the transmit power difference cases. However, as expected, we observed increase in the estimated energy level that corresponds to the primary, secondary and noise. To confirm this, one can see from FIG. 6B a complete overlap between part of the secondary signal and the padded zeros of the primary user for the 40 dB transmit power difference case, and hence, only two peaks can be seen in the distribution shown in FIG. 6D. Notice that the energy level associated with the smallest peak (secondary and noise) in FIG. 6D is roughly equivalent to the energy level associated with the middle peak in FIG. 6C), while one can easily see close to 20 dB increase in the highest peak (primary, secondary and noise) in FIG. 6D relative to FIG. 6C. The measured SINK values for the different transmit power cases are reported in Table II.

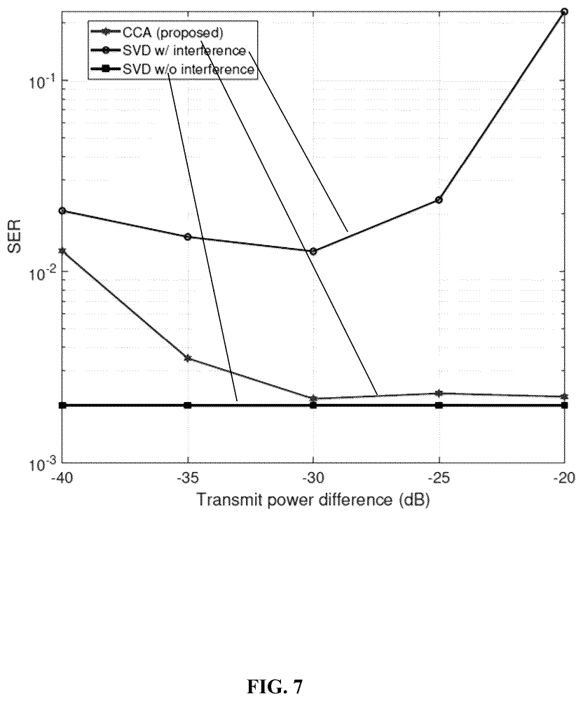

In order to demonstrate the capability of our approach to correctly decode the secondary transmission at very low SINR, we report the SER of the secondary user obtained by our CCA method at five different levels of the (average) transmit power imbalance: from −20 dB to −40 dB (corresponding secondary SINK levels are reported in Table II). FIG. 7 depicts SER results obtained by our CCA method, for all five levels of primary interference, and the corresponding SER curve obtained using the SVD-based method at the same SNR without any interference. The results are striking: CCA is remarkably insensitive to interference from the primary user. In particular, CCA achieves almost the same performance at power difference levels (−35, −30, −20, −25) dB. On the other hand, at the −40 dB level, the CCA performance degrades. This mainly happens due to the limited resolution of the analog to digital converter of our USRP for the wide dynamic range of the input signal—while the average SINK is −32 dB, there are several instances where it drops below −40 dB, and these occasional quantization errors ultimately dominate CCA performance. Despite that, CCA still achieves close to 10⁻² SER. Finally, one can see that CCA significantly outperforms the SVD method used for interference cancellation, even though the latter is in fact aided by the CCA frame structure to acquire timing—a benefit which it won't have in practice. As shown in FIG. 7, SVD performance breaks at 25 dB transmit power difference, where primary subspace estimation becomes very difficult, and hence interference cancellation does not work.

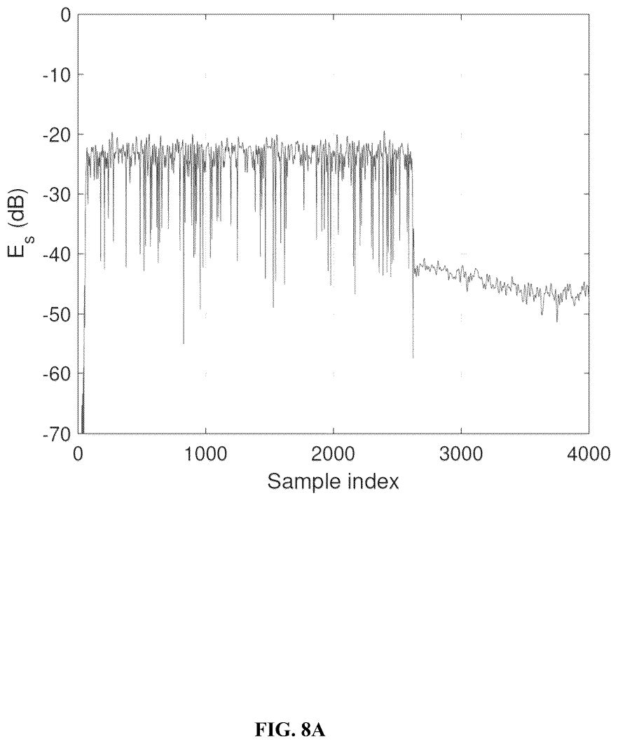

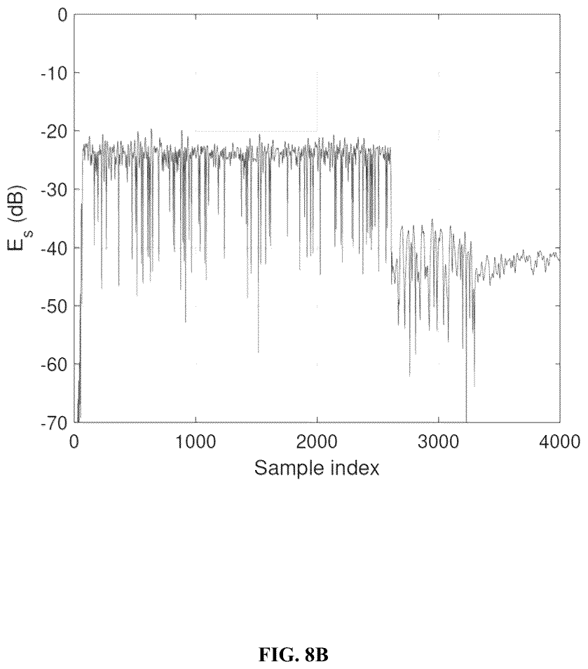

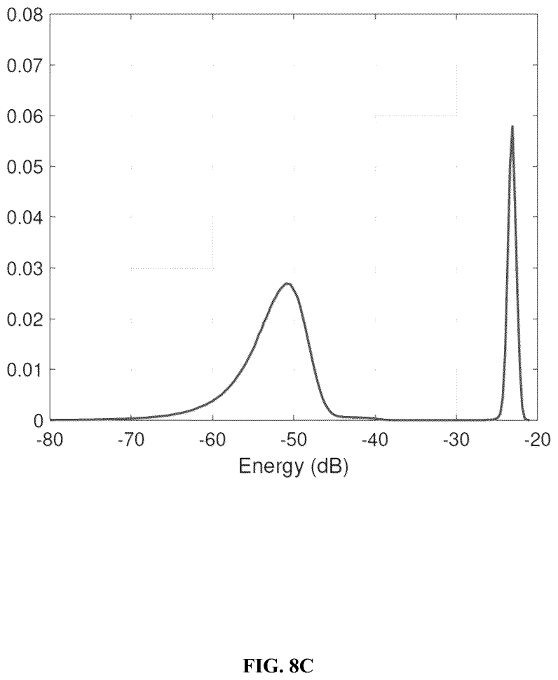

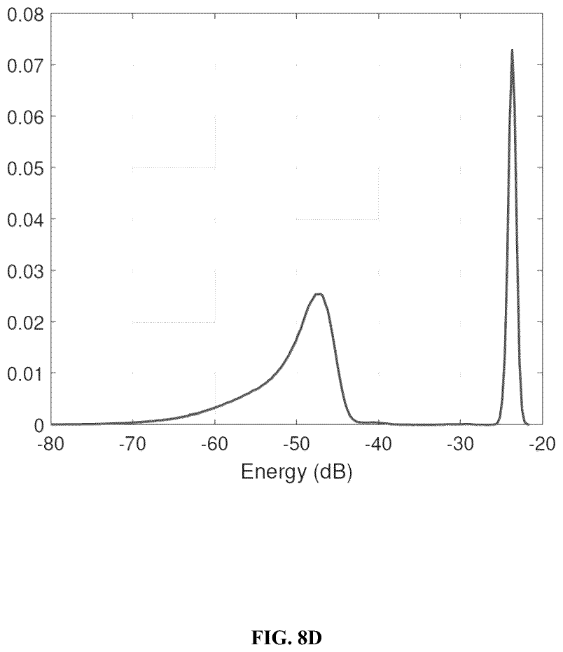

Considering the primary user's performance, we observed that the single-antenna primary receiver is completely insensitive to the secondary interference. FIG. 8A shows one of the received packets at the PRx (before down sampling), with the primary transmit power set to 0 dBm (minimum primary power in this experiment), while the secondary user is inactive. On the other hand, FIG. 8B shows one of the received packets at the PRx (before down sampling) when the secondary user is active, where there is approximately 70% overlap between the two users' packets. We observed that in the worst case setting, where the primary user power is fixed to its minimum level (highest interference from the secondary user), the same detection performance can be attained regardless whether the secondary user is active or not. This is due to the fact that the secondary interference is close to the primary's noise floor, as one can see from FIG. 8C and FIG. 8D, where the two smaller peaks in FIG. 8C and FIG. 8D correspond to the noise level and the secondary plus noise level, respectively. We observed that the SNR of the primary user is 28 dB when the secondary user is inactive, while the primary user's SINR is 25 dB when the secondary user is active.

Effect of Secondary SNR.

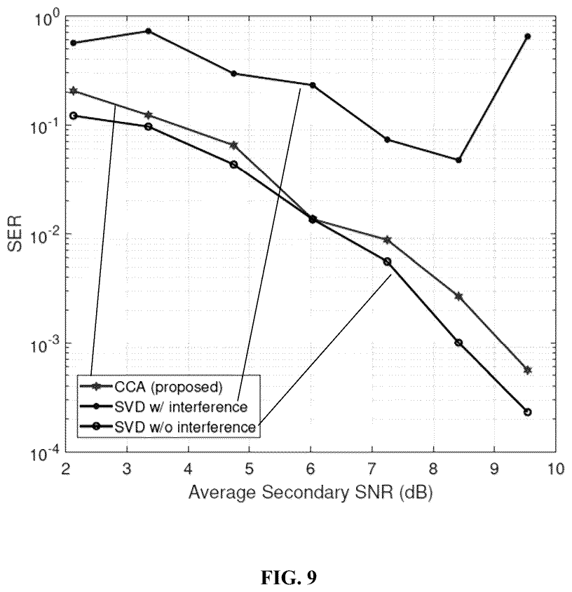

We consider another experiment to see the performance of the method under different SNR values for the secondary user. To do so, we fixed the primary transmit power to 10 dBm and varied the secondary transmit power from −23 to −17 dBm which corresponds to average SNR values between 2 dB and 10 dB, as observed. At each SNR value, we report the SER of the secondary user. FIG. 9 depicts the SER performance of the secondary user versus its SNR. It is obvious how well our method works at very low SNR/SINR values. In particular, our method can achieve 10⁻² SER at 7 dB and closely approaches what is attained by the interference-free SVD baseline at low SNR values. Further, one can see that the SVD with interference completely fails at both the low SNR and high SNR regions, where in the latter, the secondary user becomes a bit more stronger and then accurate primary subspace estimation becomes more difficult as explained in the previous experiment.

On the other hand, we observed that the secondary user does not affect the primary performance, which remains the same as is attained when the secondary user is inactive. The same SER is observed at the PRx, even at the extreme case where the secondary transmit power is −17 dBm (i.e., the highest interference to the primary).

Impact of Packet Size.

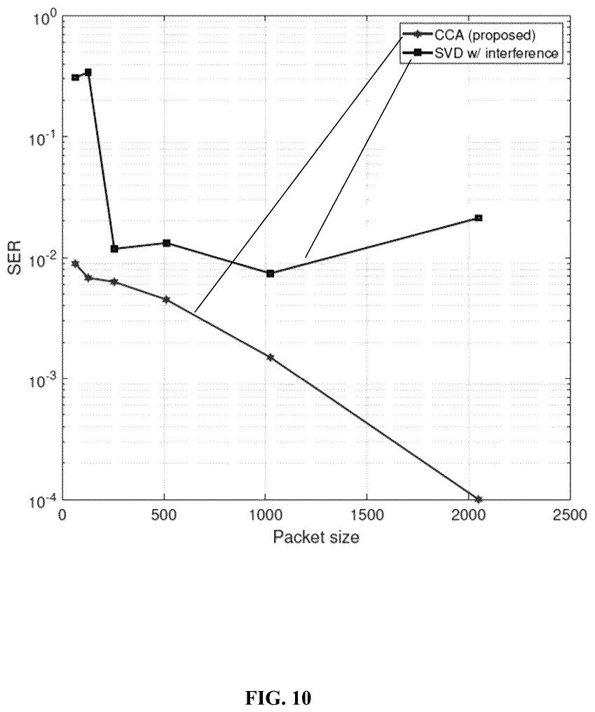

We test the performance of the method as a function of secondary packet size. The secondary and primary transmit powers are fixed to −20 dBm and 5 dBm, respectively. The measured average SNR at the secondary receiver is 7 dB. The primary packet length is set to 256 QPSK symbols. FIG. 10 shows the SER performance of the approach versus the packet size of the secondary user. We observe a significant improvement in the secondary SER when the secondary packet length increases. This is due to the fact that increasing N renders the transmit sequences closer to being orthogonal and having low auto-correlation sidelobes, which improves the performance of CCA and secondary timing synchronization. We recently established a performance analysis of CCA in [37], where we showed that increasing the packet length yields higher canonical correlation coefficient, and hence a better estimate for the common signal. This suggests that transmitting longer secondary packets provides better secondary detection performance. On the other hand, one can argue that if the channel is fast time varying, then the higher the packet length, the higher the probability of each block being subject to channel variation, thus violating the presumed mode. Hence, in setting the secondary packet length one has to take into account the coherence time of the channel, in order to choose the optimal packet length for the secondary user.

Secondary Synchronization.

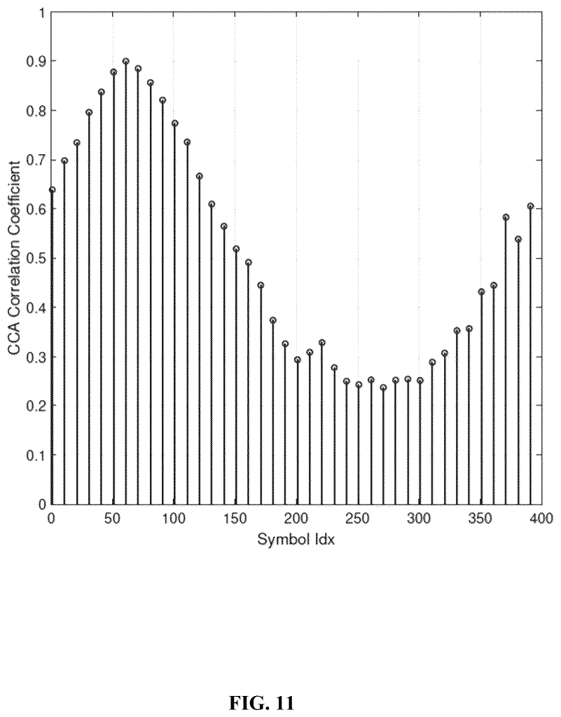

Finally, we evaluate the performance of the algorithm for finding the start time of the secondary packet. We use the same parameters as the previous experiment but the secondary packet is fixed to 256 symbols. Recall that the received packet length, before down-sampling, is 4020 samples. To find the start of the 256×2 signal, we run Algorithm 1 with a step of 10 symbols on the received signal, which resulted in solving approximately a series of 40 CCA problems. FIG. 11 shows that the highest correlation coefficient is attained at symbols index 60. We then performed an additional narrow (fine) search over a window size of 10 symbols centered at the obtained symbol index from the wide search.

The present disclosure provides a practical low-complexity data-driven spectrum sharing approach for an asynchronous underlay scenario involving a high-power primary user and a low-power secondary link. The method allows the secondary user to reliably communicate over the same channel occupied by the primary, without any coordination, and without any channel state information. The solution employs “repetition coding”: the secondary user transmits its signal twice at very low power such that it does not affect the primary user detection performance. Constructing two signal views at the SRx and applying CCA to these views, we showed that the secondary receiver can reliably decode its intended signal at moderate SNR even if it is buried under strong interference from the primary user transmission. The low-complexity unsupervised based approach can resolve the crucial low-SINR synchronization issue at the secondary receiver. Laboratory experiments using a custom-built USRP testbed confirmed the efficacy of the method in decoding the secondary signal at very low SINR in real world wireless environments.

The framework can guarantee reliable reception of the secondary underlay signal even under time-varying and intermittent interference from the primary user. Specifically, our results show that the secondary signal can be identified even if the primary channel is different across the two secondary signal blocks. To the best of our knowledge, this is the first spectrum underlay work that allows a low-power secondary user to occupy the channel with a time varying primary user in a realistic wireless environment, without i) requiring any knowledge about the primary network (waveform, modulation, channel, timing, etc.), ii) coordination between the primary and the secondary system, iii) long pilot sequences for acquisition and channel estimation for the secondary user.

It will be understood that modifications to the embodiments disclosed herein can be made to meet a particular set of design criteria. For instance, any component can be any suitable number or type of each to meet a particular objective. Therefore, while certain exemplary embodiments of the apparatus and methods of making and using the same disclosed herein have been discussed and illustrated, it is to be distinctly understood that the invention is not limited thereto but can be otherwise variously embodied and practiced within the scope of the following claims.

It will be appreciated that some components, features, and/or configurations can be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein. Additionally, the disclosure of a range of values is a disclosure of every numerical value within that range, including the end points.

The following references are incorporated herein by reference in their entirety.

### REFERENCES

[1] M. S. Ibrahim and N. D. Sidiropoulos, “Blind carbon copy on dirty paper: seamless spectrum underlay via canonical correlation analysis,” in IEEE International Conference on Acoustics, Speech and Signal Processing (ICASSP), Toronto, Canada, June 2021.
[2] A. Goldsmith, S. A. Jafar, I. Maric, and S. Srinivasa, “Breaking spectrum gridlock with cognitive radios: An information theoretic perspective,” Proceedings of the IEEE, vol. 97, no. 5, pp. 894-914, April 2009.
[3] S. Haykin, “Cognitive radio: brain-empowered wireless communications,” IEEE Journal on Selected Areas in Communications, vol. 23, no. 2, pp. 201-220, February 2005.
[4] A. Ghasemi and E. S. Sousa, “Spectrum sensing in cognitive radio networks: requirements, challenges and design tradeoffs,” IEEE Communications Magazine, vol. 46, no. 4, pp. 32-39, April 2008.
[5] T. S. Rappaport, Y. Xing, G. R. MacCartney, A. F. Molisch, E. Mellios, and J. Zhang, “Overview of millimeter wave communications for fifth-generation (5G) wireless networks—with a focus on propagation models,” IEEE Transactions on Antennas and Propagation, vol. 65, no. 12, pp. 6213-6230, August 2017.
[6] Q. Zhao and B. M. Sadler, “A survey of dynamic spectrum access,” IEEE Signal Processing Magazine, vol. 24, no. 3, pp. 79-89, May 2007.
[7] J. M. Peha, “Approaches to spectrum sharing,” IEEE Communications Magazine, vol. 43, no. 2, pp. 10-12, February 2005.
[8] S. Geirhofer, L. Tong, and B. M. Sadler, “Cognitive radios for dynamic spectrum access-dynamic spectrum access in the time domain: Modeling and exploiting white space,” IEEE Communications Magazine, vol. 45, no. 5, pp. 66-72, May 2007.
[9] Y. Zeng, Y.-C. Liang, A. T. Hoang, and R. Zhang, “A review on spectrum sensing for cognitive radio: Challenges and solutions,” vol. 2010, January 2010.
[10] T. Yucek and H. Arslan, “A survey of spectrum sensing algorithms for cognitive radio applications,” IEEE Communications Surveys Tutorials, vol. 11, no. 1, pp. 116-130, March 2009.
[11] L. M. Lopez-Ramos, Y. Teganya, B. Beferull-Lozano, and S. J. Kim, “Channel gain cartography via mixture of experts,” in IEEE Global Communications Conference (GLOBECOM), Taipei, Taiwan, December 2020, pp. 1-7.
[12] A. G. Marques, L. M. Lopez-Ramos, G. B. Giannakis, and J. Ramos, “Resource allocation for interweave and underlay CRs under probability-of-interference constraints,” IEEE Journal on Selected Areas in Communications, vol. 30, no. 10, pp. 1922-1933, November 2012.
[13] N. Yi, Y. Ma, and R. Tafazolli, “Underlay cognitive radio with full or partial channel quality information.” International Journal of Navigation and Observation, vol. 2010, July 2010.
[14] D. Denkovski, V. Rakovic, V. Atanasovski, L. Gavrilovska, and P. Ma“ho”nen, “Generic multiuser coordinated beamforming for underlay spectrum sharing,” IEEE Transactions on Communications, vol. 64, no. 6, pp. 2285-2298, May 2016.
[15] F. A. Khan, K. Tourki, M. Alouini, and K. A. Qaraqe, “Performance analysis of a power limited spectrum sharing system with TAS/MRC,” IEEE Transactions on Signal Processing, vol. 62, no. 4, pp. 954-967, January 2014.
[16] M. Hanif, H. Yang, and M. Alouini, “Transmit antenna selection for power adaptive underlay cognitive radio with instantaneous interference constraint,” IEEE Transactions on Communications, vol. 65, no. 6, pp. 2357-2367, March 2017.
[17] R. Sarvendranath and N. B. Mehta, “Exploiting power adaptation with transmit antenna selection for interference-outage constrained underlay spectrum sharing,” IEEE Transactions on Communications, vol. 68, no. 1, pp. 480-492, October 2020.
[18] R. M. Rao, H. S. Dhillon, V. Marojevic, and J. H. Reed, “Analysis of worst-case interference in underlay radar-massive MIMO spectrum sharing scenarios,” in IEEE Global Communications Conference (GLOBECOM), HI, USA, February 2019, pp. 1-6.
[19] S. Dadallage, C. Yi, and J. Cai, “Joint beamforming, power, and channel allocation in multiuser and multichannel underlay MISO cognitive radio networks,” IEEE Transactions on Vehicular Technology, vol. 65, no. 5, pp. 3349-3359, June 2016.
[20] S. Kusaladharma and C. Tellambura, “Secondary user interference characterization for spatially random underlay networks with massive MIMO and power control,” IEEE Transactions on Vehicular Technology, vol. 66, no. 9, pp. 7897-7912, September 2017.
[21] V. Nguyen, L. Tran, T. Q. Duong, O. Shin, and R. Farrell, “An efficient precoder design for multiuser MIMO cognitive radio networks with interference constraints,” IEEE Transactions on Vehicular Technology, vol. 66, no. 5, pp. 3991-4004, May 2017.
[22] S. Kashyap and N. B. Mehta, “SEP-Optimal transmit power policy for peak power and interference outage probability constrained underlay cognitive radios,” IEEE Transactions on Wireless Communications, vol. 12, no. 12, pp. 6371-6381, December 2013.
[23] A. Ghasemi and E. S. Sousa, “Fundamental limits of spectrum-sharing in fading environments,” IEEE Transactions on Wireless Communications, vol. 6, no. 2, pp. 649-658, February 2007.
[24] K. Zheng, X. Liu, X. Liu, and Y. Zhu, “Hybrid overlay-underlay cognitive radio networks with energy harvesting,” IEEE Transactions on Communications, vol. 67, no. 7, pp. 4669-4682, April 2019.
[25] P. K. Sangdeh, H. Pirayesh, A. Quadri, and H. Zeng, “A practical spectrum sharing scheme for cognitive radio networks: Design and experiments,” IEEE/ACM Transactions on Networking, vol. 28, no. 4, pp. 1818-1831, August 2020.
[26] D. Tse and P. Viswanath, Fundamentals of Wireless Communication. USA: Cambridge University Press, 2005.
[27] S. N. Affes, H. Hansen, and P. Mermelstein, “Interference subspace rejection: a framework for multiuser detection in wideband CDMA,” IEEE Journal on Selected Areas in Communications, vol. 20, no. 2, pp. 287-302, August 2002.
[28] U. Madhow, “Blind adaptive interference suppression for direct-sequence CDMA,” Proceedings of the IEEE, vol. 86, no. 10, pp. 2049-2069, October 1998.
[29] H. Hotelling, “Relations between two sets of variates,” Biometrika, vol. 28, no. 3/4, pp. 321-377, 1936.
[30] M. S. Ibrahim and N. Sidiropoulos, “Cell-edge interferometry: Reliable detection of unknown cell-edge users via canonical correlation analysis,” in IEEE Int. Conf. on Sig. Proc. Adv. in Wir. Comm. (SPAWC), Cannes, France, July 2019, pp. 1-5.
[31] Q. Wu and K. M. Wong, “Un-music and un-cle: An application of generalized correlation analysis to the estimation of the direction of arrival of signals in unknown correlated noise,” IEEE Transactions on Signal Processing, vol. 42, no. 9, pp. 2331-2343, September 1994.
[32] A. Dogandzic and A. Nehorai, “Finite-length MIMO equalization using canonical correlation analysis,” IEEE Transactions on Signal Processing, vol. 50, no. 4, pp. 984-989, August 2002.
[33] Z. Bai, G. Huang, and L. Yang, “A radar anti jamming technology based on canonical correlation analysis,” in International Conference on Neural Networks and Brain, vol. 1, Beijing, China, April 2005, pp. 9-12.
[34] M. S. Ibrahim and N. D. Sidiropoulos, “Weak target detection in MIMO radar via beamspace canonical correlation,” in 11th Sensor Array and Multichannel Signal Processing Workshop (SAM), Hangzhou, China, June 2020, pp. 1-5.
[35] A. Bertrand and M. Moonen, “Distributed canonical correlation analysis in wireless sensor networks with application to distributed blind source separation,” IEEE Transactions on Signal Processing, vol. 63, no. 18, pp. 4800-4813, June 2015.
[36] M. Borga and H. Knutsson, “A canonical correlation approach to blind source separation,” Report LiU-IMT-EX-0062 Department of Biomedical Engineering, Linkping University, 2001.
[37] M. S. Ibrahim and N. D. Sidiropoulos, “Reliable detection of unknown cell-edge users via canonical correlation analysis,” IEEE Transactions on Wireless Communications, vol. 19, no. 6, pp. 4170-4182, March 2020.
[38] M. S. Ibrahim, A. S. Zamzam, A. Konar, and N. D. Sidiropoulos, “Cell-edge detection via selective cooperation and generalized canonical correlation,” IEEE Transactions on Wireless Communications, May 2021.
[39] R. Arora and K. Livescu, “Multi-view learning with supervision for transformed bottleneck features,” in IEEE International Conference on Acoustics, Speech and Signal Processing (ICASSP), Florence, Italy, May 2014, pp. 2499-2503.
[40] X. Fu, K. Huang, E. Papalexais, H. A. Song, P. P. Talukdar, C. Faloutsos, N. D. Sidiropoulos, and T. Mitchell, “Efficient and distributed generalized canonical correlation analysis for big multiview data,” IEEE Transactions on Knowledge and Data Engineering, pp. 1-1, October 2018.
[41] C. I. Kanatsoulis, X. Fu, N. D. Sidiropoulos, and M. Hong, “Structured sumcor multiview canonical correlation analysis for large-scale data,” IEEE Transactions on Signal Processing, vol. 67, no. 2, pp. 306-319, January 2019.
[42] D. R. Hardoon, S. Szedmak, and J. Shawe-Taylor, “Canonical correlation analysis: An overview with application to learning methods,” Neural Computation, vol. 16, no. 12, pp. 2639-2664, December 2004.
[43] J. D. Carroll, “Generalization of canonical correlation analysis to three or more sets of variables,” in Proceedings of the 76th annual convention of the American Psychological Association, vol. 3, 1968, pp. 227-228.

What is claimed is:

1. A dynamic spectrum access (DSA) system, comprising:
a DSA transmitter configured to generate a complex signal for a secondary communication system, the complex signal being within a communication band A that is equal to or falls within a communication band B of a primary communication system; and
a DSA receiver including a plurality of DSA antennas and a DSA signal processing module, the DSA signal processing module configured to perform canonical correlation analysis (CCA) on the complex signal,
wherein:
the complex signal comprises a first signal and a second signal that is a repeat of the first signal;
the power of the complex signal, when received at the DSA receiver, is greater than the noise floor of the secondary communication system, but is equal to or less than the interference power from the primary communication.

2. The DSA system of claim 1, wherein:
the power of the complex signal is at least 20 dB less than the interference power from the primary communication.

3. The DSA system of claim 1, comprising:
the secondary communication system; and/or
the primary communication system.

4. The DSA system of claim 3, wherein:
the primary communication system includes a primary system receiver having at least one primary system antenna.

5. The DSA system of claim 1, wherein:
the DSA includes at least one DSA transmitter-receiver pair for the secondary communication system;
signal transmission between a primary system transmitter and a primary system receiver of the primary communication system constitutes a primary use of spectrum within communication band B;
at least one signal transmission between each DSA transmitter-receiver pair of the DSA system constitutes a secondary use of spectrum within communication band B; and
the DSA receiver of each DSA transmitter-receiver pair includes a number of DSA antennas that is greater than or equal to the sum of primary and secondary uses.

6. The DSA system of claim 1, wherein:
the DSA transmitter is configured to generate the second signal via a symbol repeat technique or a block repeat technique.

7. The DSA system of claim 1, wherein:
the DSA transmitter is configured to generate a digitally-modulated signal of the complex signal.

8. The DSA system of claim 5, wherein:
each DSA antenna receives a signal transmission from a primary system transmitter of the primary communication system and a signal transmission from the DSA transmitter;
the DSA signal processing module is configured to generate a matrix to mathematically model the complex signal, the matrix having a number of columns equal to the number of DSA antennas for each DSA receiver; and
an individual column corresponds to a baseband-equivalent signal received from an individual DSA antenna that is a sum of baseband signal transmissions weighted by complex coefficients modeling the respective propagation channels.

9. The DSA system of claim 8, wherein:
the DSA signal processing module is configured to split the complex signal into data packet Y₁ and data packet Y₂.

10. The DSA system of claim 9, wherein:
the DSA signal processing module is configured to detect the first signal via a CCA technique.

11. The DSA system of claim 10, wherein:
the DSA signal processing module is configured to detect the first signal via a maximum variance formulation of CCA so as to determine a minimum distance between liner projections of Y₁ and Y₂.

12. The DSA system of claim 1, wherein the DSA signal processing module is configured to:
identify a sample index from a sequence of data packets from the complex signal;
determine a canonical correlation coefficient for each pair of data packets of the complex signal associated with a given sample index; and
identify the sample index for which canonical correlation is maximum.

13. A dynamic spectrum access (DSA) system, comprising:
a DSA transmitter including a DSA data packet repeater module, the DSA transmitter configured to generate a complex signal that includes a first signal and a second signal that is a repeat of the first signal; and
a DSA receiver including a plurality of DSA antennas and a DSA signal processing module, the DSA signal processing module configured to perform canonical correlation analysis (CCA) on the complex signal.

14. The DSA system of claim 13, wherein:
the DSA transmitter includes a modulation and pulse shaping module.

15. The DSA system of claim 13, wherein:
the DSA transmitter includes an up conversion module.

16. The DSA system of claim 13, wherein:
the DSA transmitter includes a power amplifier module.

17. The DSA system of claim 13, wherein:
the DSA receiver includes a down conversion module.

18. The DSA system of claim 13, wherein:
the DSA signal processing module is configured to perform matched filtering and sampling on the complex signal.

19. The DSA system of claim 13, wherein:
the DSA signal processing module is configured to perform CCA based time synchronization.

20. The DSA system of claim 13, wherein:
the DSA signal processing module is configured to perform CCA based signal decoding on the complex signal.

21. The DSA system of claim 13, wherein:
the DSA signal processing module is configured to perform post-CCA carrier frequency offset and phase estimation and/or compensation prior to final symbol-level detection.

22. A method of providing dynamic spectrum access (DSA), the method comprising:
generating a complex signal for a secondary communication system, the complex signal being within a communication band A that is equal to or falls within a communication band B of a primary communication system, the complex signal comprising a first signal and a second signal that is a repeat of the first signal; and
performing canonical correlation analysis (CCA) based time synchronization and/or CCA based signal decoding on the complex signal.
